(19) United States
(12) Patent Application Publication
(10) Pub. No.: US 2019/0045811 A1
(43) Pub. Date: Feb. 14, 2019

(54) ANIMAL CHEW FORMULATION AND METHOD OF MAKING THE SAME

(71) Applicant: Spectrum Brands, Inc., Middleton, WI (US)

(72) Inventors: Joseph C. CARLEY, Blacksburg, VA (US); Benjamin MILLER, Middleton, WI (US); William D. HIMES, Radford, VA (US)

(73) Assignee: Spectrum Brands, Inc., Middleton, WI (US)

(21) Appl. No.: 15/759,774

(22) PCT Filed: Sep. 15, 2016
(86) PCT No.: PCT/US2016/051944

§ 371 Date: Mar. 13, 2018

Related U.S. Application Data
(60) Provisional application No. 62/218,891, filed on Sep. 15, 2015.

(51) Int. Cl. A23K 10/26; A23K 10/30; A23K 20/147; A23K 20/163; A23K 40/20; A23K 50/42; A23K 40/25; A23K 40/30

(52) U.S. Cl. CPC A23K 10/26; A23K 10/30; A23K 20/147; A23K 40/30; A23K 40/20; A23K 50/42; A23K 40/25; A23K 20/163

(57) ABSTRACT

Animal chews are generally formulated with a composition that generally comprises a combination of protein, carbohydrate, fiber, fat, humectants and water, which is formed by mixing, followed by a forming process, such as molding. As described herein, animal chews are made having an outer portion and an inner portion. The inner portion is contained within recesses within the outer portion and can also include runners giving the appearance of a tied rawhide bone.

This application is being filed on 15 Sep. 2016, as a PCT International Patent application and claims priority to U.S. Provisional patent application Ser. No. 62/218,891, filed Sep. 15, 2015, the entire disclosure of which is incorporated by reference in its entirety.

### FIELD OF THE INVENTION

The invention relates generally to a formulation to make an animal chew and a method of making an animal chew.

### INTRODUCTION

Chews for animals, specifically rawhide chews, are widely popular because they allow animals, such as dogs to chew for an extended period of time. Some animal chews have an edible coating that provides desirable nutrients, such as, herbal remedies, vitamins, and/or minerals. Methods for processing rawhide into animal chews are well known in the art. It is known to make rawhide chews into a bone shape having knots on the ends or pressed, comminuted, extruded, or otherwise formed into various other shapes, such as, a stick.

The process for making rawhide chews consists of the following steps. Animal hides, typically, those of livestock, are soaked in a lime solution, which removes hair from the hide. The hides are then split with the top grain being used for leather goods. The lower split is rinsed thoroughly with careful attention paid to removing all the lime solution. The split is then bleached and, after extensive rinsing, the hide is cut, rolled and shaped into forms. Typically, the rawhide is rolled and tied on each end in the form of a bone. Typically, this procedure is done by hand, although similar results can be obtained by machine. The formed rawhide is placed on vented, bakery-type racks and then put into a drying room. Through a natural process known as “moisture extraction,” moisture is extracted from within the rawhide, enabling the rawhide to be thoroughly dried from the inside out. The moisture extraction combines warm airflow of approximately 60 degrees Celsius and dehumidification. This slow drying process takes between two and five days and prevents the rawhide from drying on the outside while retaining water in the inside, which can cause the raw hide to rot.

Patents disclose various methods and articles relating to the processing of rawhide for use as a pet chew. For example, U.S. Pat. No. 2,988,045, issued to Fisher on Jun. 13, 1961 (Fisher), discloses an animal toy made from rolled rawhide. A simulated animal bone is prepared by rolling a sheet of wet rawhide into a cylindrical form. While the rawhide is still wet, at least one knot is tied on the rawhide, such as on one end. Moreover, both ends could comprise a knot in order to simulate an animal joint. The product is then dried.

U.S. Pat. No. 4,880,642, issued to Berends on Nov. 14, 1989 (Berends), discloses a method of making chewing bones for pets. Chews for pets are made from sinews or tendons of cattle and other livestock by the method of cooking the tendons and sinews in water for a period of five hours, followed by the removal of meat and fat, and then baking at a temperature of at least 200 degrees C., until they are completely or substantially completely hardened.

U.S. Pat. No. 5,476,069, issued to Axelrod on Dec. 19, 1995 (Axelrod), discloses a molded rawhide chew toy. A rawhide-derived dog chew is provided, wherein rawhide is comminuted, melted, and then injection molded and, finally, allowed to dry. Axelrod further discloses that after the rawhide is comminuted, various attractants and/or certain nutrients such as, for example, vitamins, may additionally be added to the dried rawhide particles before it is injection-molded.

Coating can be applied on rawhide chews by using a baste. Conventional baste may be used to provide desired coloring and/or flavoring or odor to make the chew toy more appealing to pets and their owners. Particular baste formulations can provide a more natural-looking color that pet owners are more inclined to purchase. For example, U.S. Pat. No. 5,673,653, issued to Sherrill on Oct. 7, 1997 (Sherrill), discloses various types of bastes applied to rawhide chews. Other additives can be included in the baste to reduce odor or to provide dental care for pets by removing or preventing plaque or other deleterious build-up from the pet's teeth. Many of the disclosed chews are concerned with providing dental care for animals that chew on a chew. For example, U.S. Pat. No. 5,100,651 issued to Boyer on Mar. 31, 1992 (Boyer), discloses a health product for caring of the teeth of a dog, consisting of a support made from a substance consisting of an animal skin. The support has incorporated or absorbed various water soluble active elements selected from anti-decay agents consisting of sodium fluoride, a sodium monofluorophosphate or a mixture thereof.

There is currently a need for an animal chew that can be manufactured in a cost-effective manner that provides a soft inner composition placed within the hard external layer of the animal chew that keeps the dog interested in the animal chew for a longer period of time as compared to traditional rawhide chews. There is also a need for an animal chew with a reduced incidence of splintering during use, as commonly found with traditional rawhide animal chews.

### Animal Chew Formulation and Methods

The animal chew described herein is directed to an edible animal chew, which comprises a combination of protein, carbohydrate and fat. Additionally, the edible animal chew may optionally include humectants and water. The formulations described herein provide a composition used to form an animal chew that is substantially free from rawhide. The animal chew can be formed using injection molding or other processing methods disclosed herein. These processes can be modified to produce a single-component or mono-component animal chew, and/or a two-component or dual-component animal chew, and/or a multi-component animal chew.

### DESCRIPTION OF THE DRAWINGS

FIG. 1 is an illustration of an animal chew.

FIG. 2 is an illustration of an animal chew with internal channels shown in dashed lines.

FIG. 3 is a cross-section view of the internal channels positioned through the outer portion.

### DETAILED DESCRIPTION

Animal Chew

In a traditional rawhide animal chew, a dog will begin to chew the outer layer of the rawhide. Over time, portions of a rawhide chew will begin to disintegrate and lose physical integrity. As the rawhide is exposed to continuous chewing, the dog begins to become disinterested in the rawhide chew due in part to the failure of the rawhide chew to provide a chewing enhancement (i.e., taste or texture). Further, a rawhide chew over time will soften and will not satisfy a dogs desire to chew.

The animal chew and methods described herein address the problems with traditional rawhide chews. In particular, there is the need for a non-brittle animal chew that can be manufactured in a cost-effective manner. Further, there is a need for a product that a dog will continue to chew without losing interest until the animal chew has been completely disintegrated.

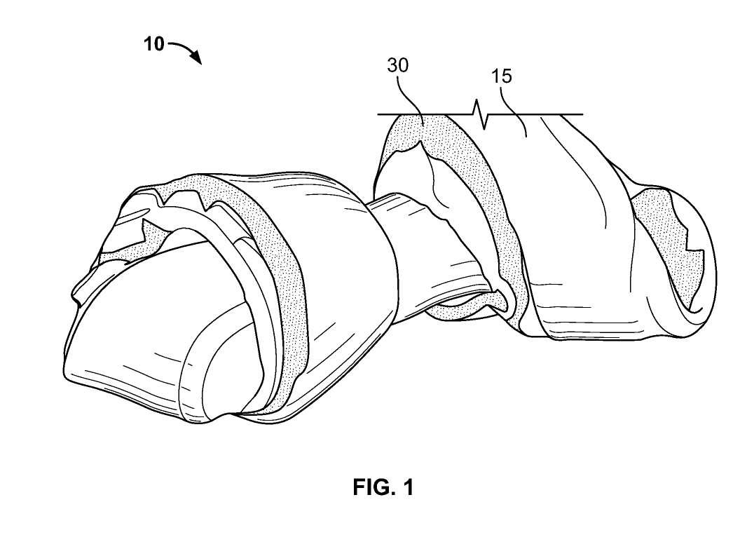

Referring now to FIGS. 1-3, animal chew 10 generally comprises an outer portion 15 and inner portion 20 (shown in FIG. 3). In general, the outer portion 15 is a hard composition that has similar hardness characteristics of a traditional rawhide chew. Since the outer portion 15 is the primary portion along the external surface of the animal chew 10, it is likely the first point of contact during chewing. Thus, the outer layer is designed to have more structural integrity. This can be achieved by increasing the starches and other long chain and/or complex carbohydrates within the outer portion 15 formulations. The outer portion 15 is formulated to create a smooth outer appearance. In alternative embodiments, outer portion 15 is formulated in a manner that provides a rough surface texture.

In some example embodiments, proteins and carbohydrates make-up at least 50% of the outer portion 15. These proteins include plant proteins, such as wheat, rice, potato, corn, sweet potato, pea, bean and other fruits, vegetables, herbs and combinations thereof. More specifically, the outer portion 15 comprises about 10% to about 60% protein, 0% to about 10% fat and 1% to about 10% fiber. Optionally, outer portion 15 comprises about 15% to about 25% humectant and about 10% to about 20% water. In other example embodiments, outer portion 15 comprises 10% to 60% protein, 0% to 10% fat and 1% to 5% fiber.

The formulation of outer portion 15 is such that outer portion 15 generally comprises physical properties such as a toughness. Outer portion 15 comprises a toughness measurement of about 200 kg*mm to about 900 kg*mm. It will be readily appreciated by one of ordinary skill in the art, in view of the description herein, to adjust the mixture in a manner to give outer portion 15 a toughness measurement within the aforementioned ranges.

In some example embodiments, animal chew 10 comprises an outer portion 15 that is substantially free from a rawhide product. Thus, outer portion 15 does not have the same physical characteristics of traditional rawhide chews. Specifically, outer portion 15 does not have surface contours that are granular, thereby giving animal chew 10 a different texture than traditional rawhide chews. Despite differences in texture, the outer surface of animal chew 10 will have visual characteristics similar to a traditional rawhide chew. This is achieved by the process of injection molding an outer portion composition described in further detail below.

In some example embodiments, outer portion 15 is formulated in a manner to reduce, if not eliminate the granular nature of the outer portion 15. For instance, the outer portion composition is formed from a substantially homogenous mixture, thereby forming a non-granular outer portion. In the event that increased granular texture is desired, a heterogeneous mixture can be used for the outer portion composition.

The inner portion 20 is formulated to create a rough-textured appearance, similar to the texture of a meat strip or meat product. The inner portion 20 is also formulated to create a taste similar to a meat product. More specifically, the inner portion 20 may comprise ingredients selected from a group consisting of protein, meat, meat preparations, palatability enhancers, binders, fillers, glycerin, preservatives, colorings and combinations thereof. In one example embodiment, the inner portion 20 is formulated with a red color to mimic a meat strip, giving the appearance of a tied rawhide bone.

The inner portion 20 comprises about 10% to 60% protein, 1% to 10% fat and 1% to 5% fiber. In another example embodiment, inner portion 20 composition comprises about 15% to about 30% protein, about 3% to about 15% fat, about 35% to about 65% carbohydrate, about 15% to about 25% humectant, and about 10% to about 20% water.

Additionally, inner portion 20 is formulated to be softer than outer portion 15. In order to achieve a desired level of softness for inner portion 20, the addition of optional ingredients, such as gelatin and/or microbial or plant gums such as, but not limited to, Xanthan, Guar or Locust bean gum to inner portion 20 can be utilized. It should be appreciated that combinations of optional ingredients may be used to provide a desired softness.

Either or both of the outer portion 15 and inner portion 20 may comprise additional ingredients. A non-exclusive list of ingredients include: flavorants, colorants, nutrients, attractants, vitamins, minerals, herbs, breath-enhancers, synthetic polymers, starch, rice meal, soybean, casein, protein, rawhide, dairy and meat byproducts, fruit and vegetable matter and combinations thereof. The inner portion 20 and outer portion 15 are formulated in a manner to provide different physical, optical, nutritional, sensual or compositional properties.

In some embodiments, outer portion 15 and inner portion 20 comprise flavoring. For instance a non-exclusive list of flavorings include: chicken liver, peanut butter, chicken, duck, pork, beef, lamb, fish and combinations thereof. In one example embodiment, peanut butter is used. It should be appreciated that peanut butter, similar to other flavoring options, can be incorporated in inner potion 15 and/or outer portion 20 as a homogenous blend. Alternatively, the flavorings, such as peanut butter, may be used as a coating. Moreover, the flavoring, such as peanut butter and the like, may form a heterogeneous mixture.

The other additional ingredients for inner portion 15 and outer portion 20 include, but are not limited to fats, fibers, dental supplements, skin and coat supplements and vitamin supplements. It should be appreciated that in formulations that already include protein, fat and fiber, additional proteins, fats and/or fibers may be added. Fats are selected from a group consisting of animal fats (e.g., pork and the like), fish oil (e.g., salmon, herring and the like) or plant oils (e.g., coconut, palm, soybean, safflower, sunflower, canola and the like) and combinations thereof. Fibers are selected from a group consisting of soluble and insoluble dietary fibers. A non-exclusive list includes cellulose, arabinoxylans, inulin, lignin, waxes, chitin, pectins, beta-glucans, oligo-saccharides and combinations thereof.

Outer portion 15 and inner portion 20 may also comprise supplements. For example, dental supplements within the scope of the invention are selected from a group consisting of sodium bicarbonate, parsley and other ingredients shown to support dental and/or gum health. Skin and coat supplements are selected from a group consisting of omega-3, omega-6, omega-9 unsaturated fatty acids and combinations thereof. Vitamin supplements are selected from a group consisting of Vitamin A, B, C, D3, E and combinations thereof.

The inner portion 20 and outer portion 15 may differ in their functionality when consumed by an animal. For example, animal chew 10 may include one ingredient that can provide nutritional supplements for improving skin and coat, while another ingredient can provide nutritional supplements to address joint problems. In such a fashion, the inner portion 20 and outer portion 15 are processed under selected conditions that can prevent a particular nutritional supplement from degrading due to a given heat and shear profile experienced in molding.

The inner portion 20 and outer portion 15 are made by preparing compositions that are compatible with manufacturing processes, such as injection molding. Animal chews are generally formulated with a composition that comprises a combination of protein, carbohydrate and fat. Optionally, other ingredients may be added, such as fiber, fat, humectants and water. In some example embodiments, animal chew 10 is formulated to produce a product that is nutritionally advantageous with required amounts of protein, fat, vitamins, minerals, moisture as well as carbohydrates.

Animal chew 10 can optionally include a coating that is applied during the molding process or subsequent to the molding process, depending on the operation of the coating. For instance, a coating may be used to enhance appearance, color, sheen or external texture of animal chew 10. Additionally, a coating can be applied to reduce animal chew 10 coloring from staining a surface, such as carpet.

As described above, the animal chew is formulated in a manner to provide a substantially smooth outer surface. As best shown in FIG. 3, outer portion 15 is processed in a manner that creates at least one recess 25 running through outer portion 15, which allows for inner portion 20 to be placed within outer portion 15 during a subsequent process step, described in more detail below.

Animal chew 10 enhances a dog's desire to chew for extended periods of time compared to traditional rawhide chews. When animal chew 10 is in use, a dog, as one example, chews the outer portion 15. Outer portion 15 slowly disintegrates and is digested by the dog with small channels of the inner portion 20 continually being available for the dog to taste throughout the entire animal chew. This arrangement provides the animal chew 10 with an attractive taste as inner portion 20 is slowly exposed during the lifespan of animal chew 10. Additionally, the dog will have to gnaw or chew the outer portion 15 to get at small sections of the inner portion 20. It should be appreciated that even though inner portion 20 is a smaller amount of material compared to outer portion 15, the dog will continue to chew outer portion 15 as the inner portion 20 is continually made available from the recess 25 (FIG. 3) within outer portion 15. Similarly, the outer portion that remains in the latter part of the chewing process will remain hard. This feature also gives an improved chewing experience for the dog.

It should further be appreciated that the difference in physical characteristics between the outer portion 15 and at least one inner portion 20 provides, for instance, an attractive treat or chew for an animal or pet, namely a dog. As discussed above, the inner portion 20 having a meat-taste running substantially through the outer portion 15 will keep the dog interested in the animal chew 10 for an extended period of time. Further, the outer portion 15 is configured to be a marked improvement compared to rawhide chews in that the outer portion 15 is formulated in a manner that does not splinter for an improved and safe chewing experience.

Method of Making

The methods of making animal chew 10 generally comprise forming molded compositions from a mixture of ingredients that undergo an extrusion and injection molding process. Formation of the outer portion composition and inner portion composition is achieved at about atmospheric pressure with mixing of the components being prepared in a conventional commercial-grade mixer. The various ingredients described above can be added over a period of time or in a one-shot manner. In example embodiments, the composition mixture undergoes an extrusion process to manufacture pellets. The pellets are subsequently melted and formed into particular shapes by post-extrusion forming, such as injection molding.

The extrusion process generally begins with the combination of dry base ingredients. The dry ingredients typically include carbohydrates, proteins and fat. It should be appreciated that the fat component may be a dry ingredient, or may be in a semi-solid form. Once the dry ingredients are combined, they are mixed together, which forms a base mixture. Once the base mixture is substantially uniform, additional ingredients can be added depending on the desired contents of the final end product. For example, liquid ingredients may be added to allow for the mixture to be molded into a mass that can be readily pelletized. Furthermore, additional ingredients, such as vitamins, can be added to the dry mixture. It should be appreciated that the use of dry and liquid ingredients can be interchangeable depending on the desired composition of the pellets. One of ordinary skill in the art will appreciate the variety of ingredients and the best state (liquid, semi-solid or dry) to combine base ingredients or optional ingredients to final pellet recipe.

The optional ingredient(s) are simultaneously or separately added at any time during the extrusion process until the injection molding process. In this sense, the optional ingredient(s) may be added to the dry base mixture, or may be added to the water, before they are pelletized. The optional ingredient(s) can also be added to the base mixture after pellets are formed, even if other optional ingredient(s) were included in the pellet formulation. Further optional ingredient(s) can be added just prior to the outer portion composition or inner portion composition being injected into the molding apparatus. In example embodiments, optional ingredient(s) are homogeneously integrated into the homogeneous base composition which may be obtained in the form of a mass, or in the form of pellets. More than one optional ingredient(s) may be added independently at different stages and in different ways as above explained. Further, additional dry blending of the ingredients can be done typically at room temperature for a period of time of about 5 to 60 minutes. The dry-blended mixture can then be optionally mixed with the hot water to form a composition available for injection molding without the need for pellets from the batch.

Accordingly, in connection with the above outer portion and inner portion compositions, vitamins, minerals, flavorings, dyes and/or herbs may be added with the base ingredients during the extrusion process, or may optionally be combined into the outer portion composition or inner portion composition, just prior to delivery to the injection molding apparatus. It should be appreciated that the vitamins, minerals and/or herb additives herein can be injection molded in the outer portion composition mixture without substantial thermal degradation of such additives, which degradation may attenuate or eliminate their therapeutic effect. Thus, the optional ingredients are added in a manner that will allow a substantial amount of ingredients to remain non-degraded throughout the injection molding process.

In some example embodiments, the ingredients may include an additional conditioning step to protect the degradation of various ingredients. Preferred methods also include the step of pre-conditioning the mixture prior to injection molding and the step of cooling the injection molded body to room temperature after molding. The powder and liquid can be pre-conditioned in a conditioning drum before preparing the final inner portion composition or outer portion composition for extrusion

Once the composition formulation for extrusion is established, the composition (inner or outer) is heated in an extruder container or barrels. The temperature profile of the extruder apparatus is determined by, among others, the composition ingredients, pressure, time, stirring paddle speed and shear rate. Depending on the selected amounts and the selected ingredient(s) to be processed, different processing times are necessary to prepare the homogeneous composition. In a particular embodiment, the mixture of selected ingredient(s) is processed in an extruder for a period of time typically ranging between 0.05 to 10 minutes. In alternative embodiments, the mixture of selected ingredient(s) is processed in an extruder for a period of time comprising between 0.05 to 5 minutes. In other alternative embodiments, the mixture of selected ingredient(s) is processed in an extruder for a period of time comprising between 0.05 to 3 minutes.

The extruded mixture solidifies within a few seconds to minutes, depending, for example, on the size of the extruded portion, the ingredients of the composition, the temperature of the composition, and other factors. In one example embodiment, a continuous flow of composition (inner or outer) is extruded through one or several dies. Once the composition flows through the one or several dies, the composition is exposed to a cooling process. This cooling process is typically performed using an air stream. Once the composition is sufficiently cooled, the composition is pelletized by granulators into pellets. The pellets may optionally be shaved or smoothed to provide a uniform size and shape amongst the pellet batch. The pellet size typically comprises between about 1 and 100 mm. The solid pellets can optionally be stored and later used to form solid shaped articles, such as animal chews.

Pellets prepared according to methods described above are transferred into the hopper of an injection molding machine. The temperature along the barrel and the die temperature are set to at least 75° C. The cavity of the mold has the negative shape of a dog bone. At start of the injection phase the molding apparatus is set to at least about 70° C.

Temperature is critical for monitoring and controlling the animal chew 10 injection molding process. The heating and cooling system should be capable of measuring and controlling the temperature of all sections of the injection mold apparatus. Independent control of each section is preferred although not a requirement to form the animal chew 10 described herein. Temperature ranges for the process of preparing the composition that form the outer portion 15 and at least one inner portion 20 may include but are not limited to ranges, such as; 40 Celsius to 130 Celsius, 80 Celsius to 120 Celsius and 90 Celsius to 110 Celsius.

Once the outer portion composition and/or inner portion composition are prepared for the molding process, the compositions are loaded in the injection molding apparatus. In at least one example embodiment, the outer composition in pellet form is first loaded in the injection molding apparatus.

The molding process includes at least one mold, which comprises at least two mold plates. When pressed together, the mold plates form an internal cavity forming the outer portion 15 of the animal chew 10 whereby the mold has the external surface contours of outer portion 15 machined into them. Additionally, at least one of the plates will comprise a gate, or a portion thereof, to allow for an animal chew 10 composition (outer or inner) to be injected in the internal cavity of the mold. Still further, at least one of the mold plates will comprise at least one pin that is integrally related to the internal wall of the mold plate cavity. In this regard, once the outer portion is injected in the mold cavity, the at least one pin will allow for the outer portion 15 to engulf the at least one pin.

In at least one example embodiment, the molding plates are pressed together, and the first composition is injected into the cavity through a gate. Prior to injection, at least one pin is positioned in the cavity. In this example embodiment, the pin is positioned to allow for the recess 25 of animal chew 10 to be formed. In alternative embodiments the at least one pin may be placed in the cavity after injection of the outer portion 15 composition. In at least this example embodiment, the at least one pin is positioned in the outer portion composition before the composition becomes too hard to conveniently insert the at least one pin. It should also be appreciated that multiple internal portions can be formed by placing multiple pins within outer portion 15 prior to (or immediately after) the first injection step.

When injected with the outer portion composition, the cavity will be filled and form the outer portion 15, thereby forming external surface of the animal chew 10. The cavity surface of the mold should be fabricated from a material that will enhance product release upon completion of the molding step(s). In addition to the cavity surface of the mold, the at least one pin should also be made from a material that will allow for easy removal from outer portion when mold plates are separated. Alternatively, or in addition, the surface(s) may also comprise a protective coating to prevent wear on mold cavity surfaces or to facilitate product integrity when being removed. After the injection phase the mold is cooled to expedite the hardening process. Once the outer portion 15 of animal chew 10 is sufficiently hardened and the mold has reached an appropriate cooling temperature; the outer portion 15 of the molded animal chew is ejected, or positioned for injection of the inner portion composition. While not wanting to be bound by any particular theory, the hardening step will generally be less than 5 minutes. In alternative embodiments, the hardening step is less than 2 minutes.

Hardening of outer portion 15 prior to injection of inner portion 20 comprises time intervals that are dependent on the specific formulation, time and temperature utilized. As shown in FIG. 3, diagonal lines depict the thickness of outer portion 15, which is also a factor that will determine the time required for hardening. In one example embodiment, the outer portion 15 is allowed to harden for at least 24 hours. In some example embodiments, the outer portion will harden in no more than 1 minute, 2 minutes, 3 minutes, 4 minutes or 5 minutes. In other example embodiments, the outer portion 15 is hardened at ambient room temperature for at least 1 day, 2 days, 3 days, 4 days, 5 days, 6 days, 7 days or 2 weeks. Alternatively, outer portion 15 is hardened at ambient room temperature for no more than 1 day, 2 days, 3 days, 4 days, 5 days, 6 days, 7 days or 2 weeks. This provides the recess 25 within outer portion 15 to sufficiently harden so that it can receive the inner portion 20 composition by high pressure injection without reducing the structural integrity of the outer portion 15.

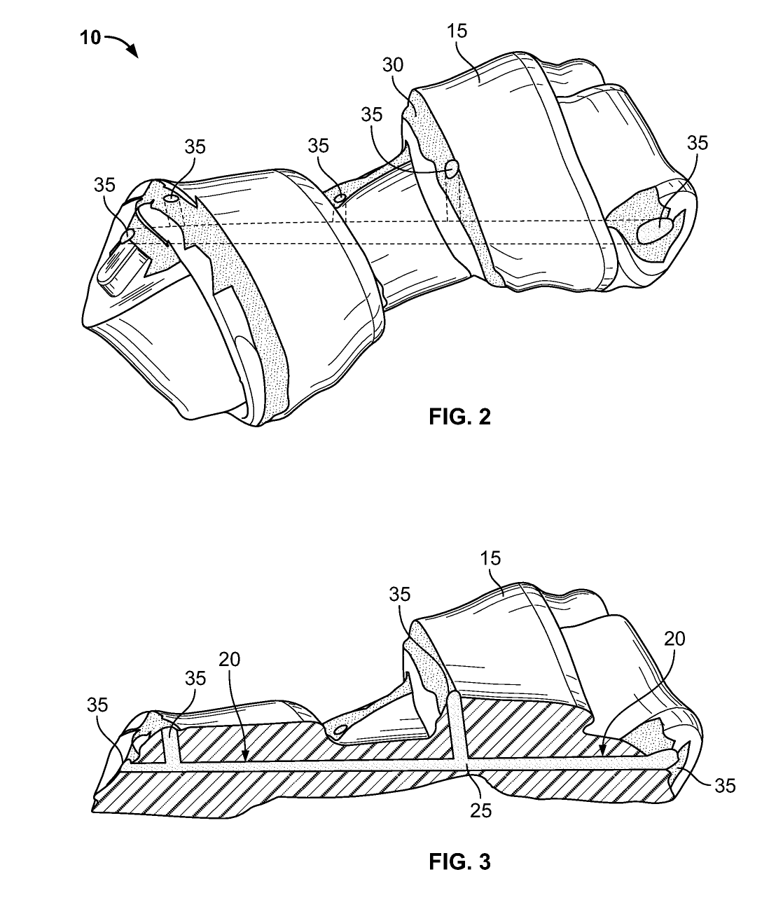

Once outer portion 15 is sufficiently hardened, the mold plates are separated, thereby removing the at least one pin from the outer portion 15. The pin is fabricated in a manner that comprises a taper where the largest pin diameter is adjacent the connection to molding plate. Thus, when the pin is removed from the outer portion 15, there is a reduced chance of the pin destroying the structural integrity of recess 25. To further enhance the removal, the pin can optionally include a coating on the exterior surface to provide an enhanced pin removal step. This coating can also provide a protective element to reduce wear and tear of pin. Upon removal of the at least one pin, a recess 25 is formed. As shown in FIGS. 2 and 3, the recess 25 is positioned along the length of the animal chew 10. Once the pin is removed, the animal chew 10 undergoes a second injection (“second shot”) to form the inner portion 20.

The inner portion 20 composition enters the animal chew 10 through an access hole 35, formed from the pin being slideably removed from the outer portion 15. The pin is removed once the outer portion composition has sufficiently hardened to maintain the integrity of the recess channel(s) formed by pin. The filling of the recess 25 area is finalized when the inner portion 20 composition fills all the voids in the animal chew recess 25. It should be appreciated that the outer portion will continue to harden after the injection of the inner portion composition. However, one of ordinary skill in the art will be able to readily ascertain the time required to sufficiently harden the outer portion to allow the inner portion composition to be injected and keep the inner portion 20 and outer portion 15 as substantially defined areas of animal chew 10. To state another way, if the outer portion is not adequately hardened, the injection of the inner portion composition will cause a marbling effect on the outer surface of the animal chew 10. This type of marbling can cause an inconsistency in the hardness to the outer portion. Further, the appearance of the marbling will be less appealing to the consumer.

In one example embodiment, the second shot occurs in the same mold cavity using a second gate to inject the inner portion 20 composition. In this example embodiment, the second gate will inject the inner portion composition while the hardened outer portion 15, having recesses therein is filled with outer portion composition. In this manner, the pressure from the injection molding apparatus is such that the inner portion composition will substantially fill all voids and recesses within and around outer portion 15. As described above, the outer portion 15 must sufficiently harden prior to initiating the injection of the inner portion composition to avoid disrupting the structural integrity of outer portion 15.

Alternatively, the second injection may occur in a second mold. In at least this example embodiment, a second set of molding plates (without integrally related pins) with a single gate arrangement may be used to inject the inner portion 20 composition. It should be appreciated that the second mold may actually be connected or part of the same molding plates, but with a separate cavity that does not include pin(s). Once the animal chew 10 is positioned to receive the second shot, the inner portion 20 composition is injected in the mold cavity.

In other alternative embodiments, the second shot may occur by injecting the inner portion 20 composition into access hole 35, in a manner similar to a caulking gun. In at least this example, the inner portion 20 composition fills the recess and will eject out through other access holes, if any, to indicate recess 25 is substantially filled with the inner portion 20 composition.

In each of the above described methods of injecting inner portion 20, the access holes 35 also serve an additional purpose of facilitating the escape of moisture during packaging and storage. Additionally, inner portion 20 will form runners 30 along multiple edges of animal chew 10. As best shown in FIGS. 1 and 2, runners 30 provide the animal chew 10 product with the appearance of a tied rawhide bone. In at least this example embodiment, a small percentage of inner portion 20 will be along the external surface of outer portion 15.

In another example, inner portion 20 and outer portion 15 are injected at substantially similar times. In this example embodiment, the outer portion 15 is first injected, and the second injection containing inner portion 20 occurs after an established time interval through a second gate. The time needed between the first and second injection is determined by the temperature, outer portion 15 formulation and second injection pressure. It should be appreciated that once the first portion 15 has sufficiently hardened, the at least one pin will still need to be removed allowing for inner portion 20 to be placed within the outer portion 15. In at least this example embodiment, the pin is slideably removed from the molding plate. The tip of the pin may remain flush with the inner cavity wall of molding plates to prevent excessive leakage of the inner portion composition in the second shot injection process. Alternatively, the pin is removed from the molding plate and a plug is placed in the void, such that the plug will be flush with the interior surface of mold cavity.

Once the injection of inner portion 20 has occurred, the animal chew 10 is placed within a room at ambient room temperature for at least 8 hours, 12 hours, 1 day, 2 days, 3 days, 4 days and/or 5 days to allow the inner portion time to sufficiently dehydrate. Once sufficiently dehydrated, the animal chew 10 is available for packaging. It should be appreciated that once the animal chew 10 is packaged, it will continue to dehydrate to equilibrium at room temperature.

The process of injection inner portion 20 is repeated if additional inner portions are desired to form multi-component dog treats. This can be particularly useful if different inner portion compositions are desired having different flavors or ingredients to provide flavor variety with a single animal chew 10. In the case of three or more portions, additional portions may be incorporated between the inner portion 20 and outer portion 15 in various ratios further enriching the textural or internal flavor and/or textural possibilities. As a result, cross-sectional areas of outer portion 15 may comprise any number of recesses or cavities that an additional inner portion can be injected.

It should be appreciated that the molded product described herein is shown in the shape of a rawhide bone, but could be made to form a dog treat of nearly any shape having multiple portions or adjacent portions of different edible compositions.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

What is claimed is:

1. An animal chew comprising:
an outer portion and
an inner portion, wherein the outer portion has at least one recess allowing for the inner portion to be placed therein.

2. The animal chew of claim 1, wherein the outer portion is a substantially plant-based material.

3. The animal chew of claim 2, wherein the plant material is selected from a group consisting of glutens, starches and fibers.

4. (canceled)

5. The animal chew of claim 1, wherein the outer portion is free from animal tissue.

6. (canceled)

7. The animal chew of claim 1, wherein the outer portion is substantially homogenous and non-granular.

8. (canceled)

9. (canceled)

10. The animal chew of claim 1, wherein the outer portion or the outer portion comprises a flavoring selected from a group consisting of chicken liver, peanut butter, chicken, duck, pork, fish, beef, lamb and combinations thereof.

11. (canceled)

12. (canceled)

13. (canceled)

14. The animal chew of claim 10, wherein the peanut butter is homogenously blended.

15. (canceled)

16. (canceled)

17. The animal chew of claim 10, wherein the peanut butter forms a heterogeneous mixture.

18. (canceled)

19. (canceled)

20. (canceled)

21. The animal chew of claim 1, wherein the inner portion or the outer portion comprises additional supplements selected from a group consisting of dental supplements, skin supplements, coat supplements and combinations thereof.

22. (canceled)

23. The animal chew of claim 1, wherein the outer portion has an average load break of less than 40 kg force.

24. The animal chew of claim 1, wherein the outer portion has an average energy at 30 mm of between 200 and 20,000 mJ.

25. The animal chew of claim 1, wherein the outer portion has an average maximum load between 20 to 200 kg force.

26. (canceled)

27. The animal chew of claim 1, wherein the outer portion composition comprises; about 10% to about 60% protein, 0% to about 10% fat, 1% to about 10% fiber.

28. (canceled)

29. (canceled)

30. The animal chew of claim 1, wherein the inner portion composition comprises about 15% to about 30% protein, about 3% to about 15% fat, about 35% to about 65% carbohydrate, about 15% to about 25% humectant, and about 10% to about 20% water.

31. A method of making an animal chew comprising the steps of:
positioning a mold having a cavity in an orientation to allow for injecting an animal chew composition, wherein the mold comprises at least two molding plates and at least one gate; and
injecting an outer portion composition in the cavity wherein the cavity contains at least one pin therein.

32. The method of claim 31, wherein the at least one pin is positioned within the cavity before injecting the outer portion composition.

33. (canceled)

34. The method of claim 31, further comprising the step of removing the at least one pin from the outer portion composition thereby forming a recess within the outer portion of the animal chew.

35. (canceled)

36. The method of claim 31, wherein the pin is integrally related to at least one molding plate.

37. (canceled)

38. (canceled)

39. (canceled)

40. The method of claim 31, wherein the inner portion composition is injected in the same mold used to inject the outer portion composition, wherein the inner portion composition is injected through a second gate.

41. The method of claim 31, wherein the inner portion composition is injected in a different mold as the injection of the outer portion composition.

42. (canceled)
